(19) United States
(12) Patent Application Publication
(10) Pub. No.: US 2022/0180249 A1
(43) Pub. Date: Jun. 9, 2022

(54) MODELLING OPERATION PROFILES OF A VEHICLE

(71) Applicant: Robert Bosch GmbH, Stuttgart (DE)

(72) Inventors: Martin Schiegg, Korntal-Muenchingen (DE); Muhammad Bilal Zafar, Berlin (DE)

(21) Appl. No.: 17/457,089

(22) Filed: Dec. 1, 2021

(30) Foreign Application Priority Data
Dec. 4, 2020 (DE) 10 2020 215 350.7

(51) Int. Cl. G06N 20/00

(52) U.S. Cl. CPC G06N 20/00

(57) ABSTRACT

To simulate automotive systems, a large number of synthetic data points characterising an aspect of the performance of a target automotive system are generator. In this way, for example, various future scenarios can be simulated and statistically evaluated. A computer-implemented method is provided for training a generative machine learning model, a computer-implemented method for generating synthetic data series using a generative machine learning model, and an associated apparatus. An associated computer program element and computer readable medium are also described.

### CROSS REFERENCE

The present application claims the benefit under 35 U.S.C. § 119 of German Patent Application No. DE 102020215350.7 filed on Dec. 4, 2020, which is expressly incorporated herein by reference in its entirety.

### FIELD

The present invention relates to a computer-implemented method for training a generative machine learning model, a computer-implemented method for generating synthetic data samples using a generative machine learning model, and associated apparatuses. Furthermore, the present invention relates to an associated computer program element and computer readable medium.

### BACKGROUND INFORMATION

The development and application of data-driven algorithms in automotive systems is becoming increasingly important for the accurate simulation of automotive systems. When simulating automotive systems, it can be advantageous to generate a large number of synthetic data points characterising an aspect of the performance of a target automotive system. In this way, for example, various future scenarios can be simulated and statistically evaluated.

For example, the generation of vehicle trajectory prediction data based upon previously obtained vehicle trajectory data falls within this topic area. A generative adversarial network (GAN) is commonly used to provide a generative model. However, such approaches may be further improved.

### SUMMARY

According to a first aspect of the present invention, a computer-implemented method for training a generative machine learning model for modelling operation profiles of a vehicle or a robot, comprising adversarially training a generator model and a discriminator model is provided. In accordance with an example embodiment of the present invention, the method comprises:
obtaining a plurality of data series from a data space, wherein each data series describes at least one operation profile of a vehicle or robot;
during at least one generation phase when training the generative machine learning model, generating a plurality of synthetic data series by sampling from a distribution;
during at least one discrimination phase when training the generative machine learning model, inputting into the discriminator model either (i) a data series from the plurality of obtained data series, or (ii) a synthetic data series from the plurality of synthetic data series;
during the at least one discrimination phase when training the generative machine learning model, classifying the input to the discriminator model as either a data series from the data space, or a synthetic data series using at least a first and a second function of the discriminator model;

wherein a plurality of inputs of the first function comprise a plurality of sequential samples of the synthetic data series, and at least one input of the second function comprises at least two data samples of the synthetic data series taken from different steps of the synthetic data series; and
iteratively training the generator model and the discriminator model of the generative machine learning model to yield a trained machine learning model comprising a trained generator model.

An effect is that the synthetic data generated by a machine learning model trained according to the method match, or more closely approximate, a real distribution with respect to specific characteristics of a real vehicle application scenario. This results in better quality simulations when a generator trained using the discriminator is used to generate synthetic data samples.

The models generated according to the above approach may also be beneficially used in the live operation of a vehicle. For example, an engine control unit may predict the fuel consumption or emission performance based on a recorded velocity profile of a vehicle driving, or based on the future route of the vehicle computed by a navigation system, or a most probable path given the car's current location. If the model is trained to predict the future vehicle operation mode, emissions or fuel consumption can be more accurately approximated for a given route, than an engine control unit controlling a vehicle using that model will, on average, enable the vehicle to reduce its emissions, for example.

A control strategy of a vehicle or robot may be adapted based on the outcome of the model. For example, in an electrically powered vehicle or robot, if a given route is predicted to deplete a battery below an unacceptable level, another route could be suggested, a driver alarm may be triggered, and/or a reduced-power mode (for example, limiting the speed of the vehicle or robot) may be engaged.

The model may be configured to rate the entries in vehicle route-finding software in terms of the fuel or emission performance. Routes having more efficient fuel performance, or lower emission characteristics, may be presented to a driver on an output interface with higher priority.

The model may analogously be used in the control unit of an electric or hybrid car, to improve the prediction of battery drain or predict recharge times, based on a prospective route.

A model trained according to the first aspect may be used to estimate the wear on vehicle components that could be caused by driving along one or more predicted routes.

Furthermore, the present aspects benefit the internal operation of a processor or system used to train a machine learning model (via a cGAN or GAN, for example). Specifically, the practical effect of the second module is to provide additional gradient information to the GAN or cGAN generator during training. This eases the task of the discriminator by focussing on domain specific features such as a series of values sampled from a distribution resulting from real or synthetic data series (optionally, a velocity-acceleration histogram), which can, in turn, directionalize the training and lead to an improvement in stability, speed, and accuracy of the training.

According to a second aspect of the present invention, there is provided a computer-implemented method for generating synthetic data samples representing synthetic operation profiles of a vehicle or robot using a generative machine learning model. In accordance with an example embodiment of the present invention, the method comprises:
configuring a generative machine learning model according to a plurality of model parameters obtained according to the method of the first aspect;
obtaining a plurality of samples by sampling from a distribution configured to provide pseudo random vectors;
decoding the plurality of the samples of the distribution to obtain a further plurality of synthetic data samples in the data space; and
outputting the further plurality of synthetic data samples representing synthetic operation profiles of a vehicle or robot.

According to a third aspect of the present invention, there is provided a computer-implemented method for training a further machine learning model for modelling operation profiles of a vehicle. In accordance with an example embodiment of the present invention, the method comprises:
obtaining a further plurality of synthetic data series representing synthetic operation profiles of a vehicle as generated according to the computer-implemented method of the second aspect;
inputting the further plurality of synthetic data series representing synthetic operation profiles of a vehicle into a further machine learning model;
iteratively training the further machine learning model; and
outputting a further plurality of model parameters of the further machine learning model for modelling operation profiles of a vehicle.

According to a fourth aspect of the present invention, there is provided an apparatus for training a generative machine learning model for modelling operation profiles of a vehicle or robot comprising adversarially training a generator model and a discriminator model stored in a memory. In accordance with an example embodiment of the present invention, the apparatus comprises:

An input interface configured to obtain a plurality of data series from a data space, wherein each data series describes at least one operation profile of a vehicle, and a processor configured, during at least one generation phase when training the generative machine learning model, to generate at least one synthetic data series by sampling from a distribution.

The processor is configured, during at least one discrimination phase when training the generative machine learning model, to input into the discriminator model either (i) a data series from the plurality of obtained data series, or (ii) a synthetic data series from the at least one synthetic data series.

During the at least one discrimination phase when training the generative machine learning model, the processor is configured to classify the input to the discriminator model as either a data series from the data space, or a synthetic data series using at least a first and a second function of the discriminator model.

A plurality of inputs of the first function comprise a plurality of sequential samples of the synthetic data series, and at least one input of the second function comprises at least two data samples of the synthetic data series taken from different steps of the synthetic data series;

The processor is configured to iteratively train the generator model and the discriminator model of the generative machine learning model to yield a trained machine learning model comprising a trained generator model. The apparatus further comprises an output interface configured to output the trained machine learning model.

According to a fifth aspect of the present invention, there is provided one or more computer program elements comprising at least (i) computer executable instructions for training, using machine learning, a generative machine learning model according to the method of the first aspect or its embodiments, and/or (ii) computer executable instructions for generating synthetic data series according to the third aspect, and/or (iii) computer executable instructions comprising model parameters for providing a generative machine learning model trained according to the first aspect or its embodiments.

According to a sixth aspect of the present invention, there is provided a computer readable medium comprising one or more of the computer program elements of the fifth aspect.

According to a seventh aspect of the present invention, there is provided a vehicle comprising a prime mover configured to provide a motive force to move the vehicle, a plurality of sensors, and a vehicle electronics unit configured at least to control the prime mover based on feedback from the sensors. The vehicle electronics unit comprises a processor configured to instantiate and to implement a trained model according to the second aspect. The trained model is configured to receive input signals from the sensors, and to apply the input signals to the trained model. The processor is configured to compute one or more response signals using the trained model. The processor is configured to adjust a configuration of one or more of the prime mover, or another output actuator of the vehicle, in response to the response signals obtained via the trained model.

In this specification, a vehicle can be any means of carrying or transporting an item (such as passengers or a payload). Examples of vehicles include an automobile, a heavy goods vehicle, van, or bus having an internal combustion engine, a hybrid engine, a gas engine, an electric powertrain, or a hydrogen hybrid. A vehicle may be an autonomous or semi-autonomous car, bus, or truck. A vehicle may be an electrical bicycle, electrical scooter factory robot, forklift truck, or an electrical wheelchair.

An operation profile of a vehicle in this specification is one or more of a plurality of sampled data series describing, for example, a velocity series, an engine temperature, engine speed, pedal positions, steering angle, or a gear change function of a vehicle driving along a route.

In an example, the trained model may also be applied to a semi-autonomous or autonomous robot, such as a warehouse robot, which is considered to be a type of vehicle in this application.

In an example embodiment of the present invention, the input to the second function of the discriminator model comprises a series of velocity-acceleration pairs sampled from a distribution resulting from real or synthetic data series. In other examples, an operation profile may encompass an integer number of vehicle stops per unit time, duration of vehicle acceleration to a predefined velocity, duration of vehicle deceleration to a predefined velocity, duration of vehicle deceleration to zero velocity, vehicle velocity versus route curvature, vehicle velocity versus route inclination, vehicle velocity versus total trip duration, integer number of gear changes per unit time, gear change function to reach a predefined velocity, gear change function to reach a predefined velocity, gear change function to reach zero velocity, gear change function versus route curvature, gear change function versus route inclination, gear change function versus total trip duration.

Therefore, in an example embodiment of the present invention, the second function of the discriminator may be evaluated to provide additional information from samples that bias the distribution of the generative model towards a distribution defined by experts.

### BRIEF DESCRIPTION OF THE DRAWINGS

FIG. 1A illustrates an approach for training a conditional generative adversarial network on route-velocity sample data.

FIG. 1B illustrates an approach for generating route-velocity sample data using a trained generative machine learning network.

FIG. 2 illustrates the discriminator of the conditional generative adversarial network of FIG. 1B in more detail.

FIG. 3A illustrates a computer-implemented method for training a generative machine learning model for modelling operation profiles of a vehicle according to the first aspect.

FIG. 3B illustrates a computer-implemented method for generating synthetic data samples representing synthetic operation profiles of a vehicle using a generative machine learning model according to the second aspect.

FIG. 4A illustrates an exemplary structure of a machine learning system.

FIG. 4B illustrates an exemplary structure of a data generator.

FIG. 5 illustrates the exemplary structure of the discriminator of a machine learning system.

FIG. 6 illustrates detailed embodiment of the discriminator of a machine learning system.

FIG. 7 illustrates an apparatus according to the third aspect.

FIG. 8 schematically illustrates a vehicle according to the seventh aspect incorporating a controller configured to apply the model trained according to the first aspect.

### DETAILED DESCRIPTION OF EXAMPLE EMBODIMENTS

An improvement to generative models is now presented, in accordance with the present invention.

A generative model is a neural network architecture capable of generating data samples that represent a set of data samples previously used to train the generative model. In an example, a generative model may be a generator of a generative adversarial network (GAN) or conditional generative adversarial network (cGAN).

A generative model for generating synthetic velocity curves (for example) might generate samples that look realistic, but the generated traces might not match statistics of the real data. For example, when generating velocity traces, external factors such as the presence of traffic lights along the route, the behaviour of other drivers at certain junctions, the time of day, the mood of the driver can cause effects that are not accounted for in conventional velocity curve generation. Such external influences constitute application-specific biases that affect the statistics of generated velocity traces.

As one example, obtaining samples from a distribution representing a velocity-acceleration histogram can be used by domain experts to judge the faithfulness of vehicle velocity traces generated by a generative network. Vehicle trips representing real-world scenarios are expected to follow a given distribution of velocity-acceleration pairs. Real-world trips can also be expected to show certain distribution of some other features, such as a number of sub-trips represented in a velocity trace (a sub-trip is identifiable, for example, by a vehicle dwell time at zero velocity for a period before continuation), or the time spent at zero velocity.

According to the aspects of this specification, it is proposed to enhance the discriminator of a generative adversarial network (GAN) or a conditional generative adversarial network (cGAN) with an additional function that improves the quality of the statistics resulting from the discrimination process. In particular, it is proposed to provide at least one extra functional block in the discriminator application-specific statistics to the discrimination function. In other words, the data-based generator of a GAN or cGAN may be enriched with domain-specific expert knowledge.

In other words, a GAN or cGAN is proposed that has an altered architecture that generates traces of sample data (for example, velocity traces) that matches or closely resembles the distributions of domain expert features.

Furthermore, the provision of a discriminator having a function that applies accurate statistics may be applied during the training procedure to generate more accurate output data, or as an evaluation metric to judge the accuracy of data generated by the generative model.

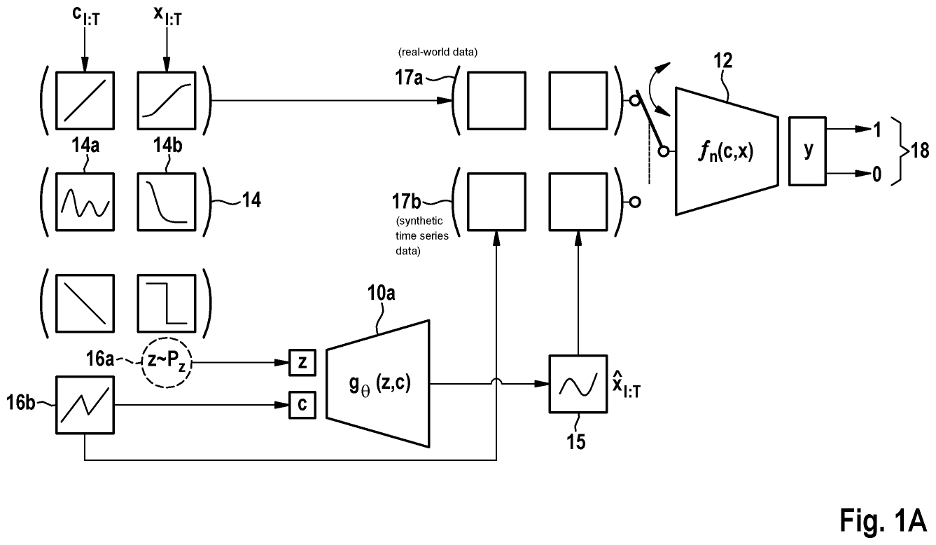

FIG. 1A illustrates an example of training a conditional generative adversarial network on route-velocity sample data. However, the technique discussed herein is applicable to a generative adversarial network (GAN) without any conditioning, for example conditioning based on the route.

In the training phase, samples c_{{1:Ti}} and x_{{1:Ti}} from a real data distribution are obtained. In this case, environment variable c_{{1:Ti}} is a matrix describing one real route, and time series x_{{1:Ti}} is a vector of velocity observations along this route. Ti is the length of the sequences.

A pair of real data samples 14 comprising a route sample 14a and a velocity sample 14b associated with the route sample 14a are randomly selected from the real data distribution and provided to the discriminator 12, thus forming a sample of real time-series data. In an example of training a GAN (as opposed to a cGAN) only one data sample is needed, rather than a pair of data samples.

A route sample 14a is a series of environment points defining an example route. A velocity sample 14b corresponds to each route sample 14a. The velocity sample 14b is a series of velocity points defining the velocity of the vehicle at points along the route sample 14a.

A generative model 10a from a previous iteration is provided with a random sample of a predefined distribution such as a Gaussian distribution or a uniform distribution. When sampling from the distribution, a vector or a sequence of vectors can be acquired. The generative model 10a is, furthermore, provided with a conditional route sample, which, in an example, is a time series.

The generative model 10a is configured to generate one or more outputs—in this case one or more generated velocities 15. The generated velocity 15 and the route sample 16b used to condition the generative model 10a form a sample of synthetic time-series data 17b.

The discriminator model 12 is trained to identify whether samples at its input represent experimentally observed data (real-world data) 17a, or synthetic time-series data 17b from the generative model 10a (fake data). Typically, the training process iterates the generative model 10a and the discriminator 12 against each other, such that the generative model 10a becomes better at defeating the discriminator model 12 (in other words, the discriminator model 12 becomes more likely to incorrectly identify experimentally observed data 17a as synthetic data 17b, and vice-versa).

In other words, the training process of the cGAN involves optimising a loss function for the generative model 10a and loss function for the discriminator model 12. More specifically, the training process is a minimax process involving minimizing the loss function of the discriminator model 12 and minimising the loss function of the generative 10a error (which implies maximising the loss of the discriminator for the synthetic data). The result is a final generative model 10b capable of generating synthetic time-series curves.

FIG. 1B illustrates an approach for generating route-velocity sample data using a trained generative machine learning network. The given route may be represented by, for example, a series of information representing the slope, speed limit, traffic density profile, road surface, number of traffic lights, or weather data, for example.

A route 20 is extracted from the database of routes 19a and may be used to condition the trained generative model 10b of the cGAN. Furthermore, a sample from the cGAN is drawn from the predefined distribution. Based on the route 20 and the sampling of the predefined distribution, the trained generative model 10b provides one or more items of synthetic data, such as a synthetic data series of velocities at specific times 22, for further use. In one example, a further use might be inputting the generated data into system simulation and analysis software 23.

In this specification, the symbols listed below have the following meaning:
x_{1:T} A series of length T with xₜ∈ [symbol] ₊, t∈{1, . . . , T}. The series describes, in an example, an operation profile of a vehicle, such as vehicle velocity. Considering a plurality of series x_{1:Ti}, Ti is the length of the series i.
   X Data space comprising a number of samples x_{1:T} optionally having variable lengths.

\hat{X} Synthetic data space.
c_{1:T} Route information, or environment conditions over T with cₜ∈ [symbol] ^{C}, t∈{1, . . . , T}. For example, slope, speed limit, or a discrete set corresponding to a gear setting. Considering a plurality of series c_{1:Ti}, Ti is the length of the series i.
[symbol] ₓ Distribution of the real operation profile data over the variable x. [symbol] _{x|c} refers to the real operation profile data conditioned on environment c, while [symbol] _{x,c} is the joint distribution of real operation profile data and environments.
[symbol] _{c} Distribution of the environment or route information over the variable c.
[symbol] ₓ Implicitly induced distribution over the variable x.
x_{1:Ti}, c_{1:Ti} Drawn from an unknown distribution [symbol] _{x,c}.
\dot{x}_{1:T} A series of length T with acceleration at each time step.
z_{1:T} Noise at each time step with zₜ∈ [symbol] ^{Z}, t∈{1, . . . , T}. Drawn from a known distribution, i.e., zₜ˜ [symbol] _{Z} (e.g., normal distribution, uniform distribution).

The notation definitions given above are for the illustration of the specific examples given in this disclosure, and are not limiting to the overall technical concept. In particular, multivariate time series may be generated with xₜ in R^{D}, where D is the number of variables to be generated. At places in the figures where the symbols “x”, “c”, “z” occur, this is intended to denote a shorthand for “x_{1:T}”, “c_{1:T}”, and “z_{1:T}”.

Although the subscript T has been used to index the series given above, and examples given herein are in terms of time series, the technique is not restricted to this. For example, the series is, referenced to the distance step, or the gear setting.

The series x_{1:T} may be univariate or multivariate. In an example, the series is a time series or a distance-based series.

Each element x_{1:Ti}, c_{1:Ti} in the plurality of series may have different lengths.

In the example of FIG. 1A, the cGAN objective is given real data x_{1:Ti}˜ [symbol] ₓ, and learns to draw samples from [symbol] ₓ. A generator model (network) 10a g(z_{1:T}, c_{1:T}) is configured to sample from an implicitly induced distribution [symbol] ₓ. A minimization is performed to minimize the discrepancy div( [symbol] ₓ, [symbol] ₓ) between the real and induced distributions by adversarial training. In an example, the discrepancy may be reduced by Jensen-Shannon divergence, Wasserstein distance, or Maximum Mean Discrepancy (MMD). Given a generator model g and a discriminator model (critic) ƒ, this corresponds to the minimax objective

$${min}_{g} {max}_{f ∈ ℱ} V ( {ℙ}_{x} , {ℚ}_{x} ) .$$

The term

$${max}_{f ∈ ℱ} V ( . )$$

refers to the estimation of the divergence, which the generator then attempts to minimize.

In an example, applying the Wasserstein distance W( [symbol] ₓ, [symbol] ₓ) in the GAN setting, i.e., without conditioning on the environment/route information, between the two distributions:

$$W ( {ℙ}_{x} , {ℚ}_{x} ) = {sup}_{f ϵℱ} {𝔼}_{{x}_{1 : T} \sim {ℙ}_{x}} [ f ( {x}_{1 : T} ) ] - {𝔼}_{{z}_{1 : T} \sim {ℙ}_{z}} [ f ( g ( {z}_{1 : T} ) ) ] \qquad ( 1 )$$

Where [symbol] consists of 1-Lipshitz functions. The minimax objective thus becomes:

$${min}_{g} {max}_{f ∈ ℱ} {𝔼}_{{x}_{1 : T} \sim {ℙ}_{x}} [ f ( {x}_{1 : T} ) ] - {𝔼}_{z \sim {ℙ}_{x}} [ f ( g ( {z}_{1 : T} ) ) ] \qquad ( 2 )$$

A conditional GAN (cGAN) is provided by approximating the joint distribution of route information and vehicle operation profiles [symbol] _{x,c} with another distribution [symbol] _{x,c}. With [symbol] _{x,c}= [symbol] _{x|c}· [symbol] _{x,c}, the generator model (network) 10a may be trained to sample from [symbol] _{x|c}. The discrepancy between the real and induced distributions div( [symbol] _{x,c}, [symbol] _{x,c}) may be minimized via adversarial training. With Wasserstein distance set as the divergence measure, the cGAN objective becomes:

$$becomes : \\ W ( {ℙ}_{x , c} , {ℚ}_{x , c} ) = {sup}_{f ϵℱ} {𝔼}_{{x}_{1 : T} , {c}_{1 : T} \sim {ℙ}_{x}} [ f ( {x}_{1 : T} , {c}_{1 : T} ) ] - {𝔼}_{{z}_{1 : T} \sim {ℙ}_{z} , {c}_{1 : T} \sim {ℙ}_{c}} [ f ( g ( {z}_{1 : T} , {c}_{1 : T} ) , {c}_{1 : T} ) ]$$

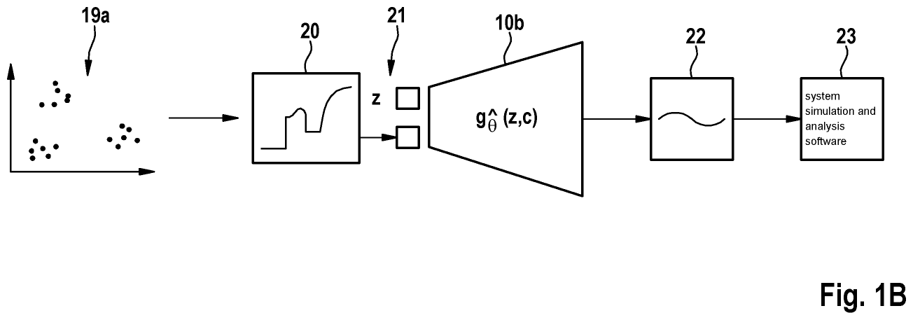

FIG. 2 illustrates the generator and the discriminator of the conditional generative adversarial network (cGAN) of FIG. 1B in more detail. Like features are denoted with like reference numerals. Row 24 is a simplified illustration, and row 25 is a detailed illustration of an example model (network) architecture of the cGAN. The generative model 10b is implemented, in an example, by a recurrent neural network (LSTM 10c). The particular example illustrated uses Long Short-Term Memory units to implement the generative model 10b, although other variations may be used. Inputs to the LSTM are extracted from the route 16b.

In FIG. 2, two sets of environment condition time sequences are extracted as features from the route 16b. The first environment condition time sequence defines the slope along the route. The second environment condition time series defines the speed limit along the route. A skilled person will appreciate more, or fewer, environment time series may be applied as inputs to the LSTM 10c. A noise sample 16a (z) at each time step is drawn from P_{Z} and input to the LSTM 10c. The generative model comprising the LSTM 10c generates, from these inputs, an appropriate synthetic velocity time series.

The first environment condition time sequence defining the slope along the route, the second environment condition time series defining the speed limit along the route, and the generated synthetic velocity time series are applied to the discriminator 12. In the illustrated example, the discriminator 12a is also a recurrent neural network such as a long short-term memory.

The cGAN illustrated in FIG. 2 may be further improved. In particular, the statistical distribution of realistic velocity time series may be skewed by realistic driving conditions caused by, for example, the effect of traffic lights, weather conditions, driver mood, speed camera positions or time of day.

According to a first aspect, there is provided a computer-implemented method 30 for training a generative machine learning model for modelling operation profiles of a vehicle or a robot, comprising adversarially training a generator model and a discriminator model, wherein the method comprises:
obtaining 32 a plurality of data series from a data space, wherein each data series describes at least one operation profile of a vehicle or robot;
during at least one generation phase when training the generative machine learning model, generating 33 a plurality of synthetic data series by sampling from a distribution;
during at least one discrimination phase when training the generative machine learning model, inputting 34 into the discriminator model either (i) a data series from the plurality of obtained data series, or (ii) a synthetic data series from the plurality of synthetic data series;
during the at least one discrimination phase when training the generative machine learning model, classifying 35 the input to the discriminator model as either a data series from the data space, or a synthetic data series using at least a first and a second function of the discriminator model;

wherein a plurality of inputs of the first function 10 comprise a plurality of sequential samples of the synthetic data series, and at least one input of the second function 26 comprises at least two data samples of the synthetic data series taken from different steps of the synthetic data series; and
iteratively training 36 the generator model and the discriminator model of the generative machine learning model to yield a trained machine learning model comprising a trained generator model.

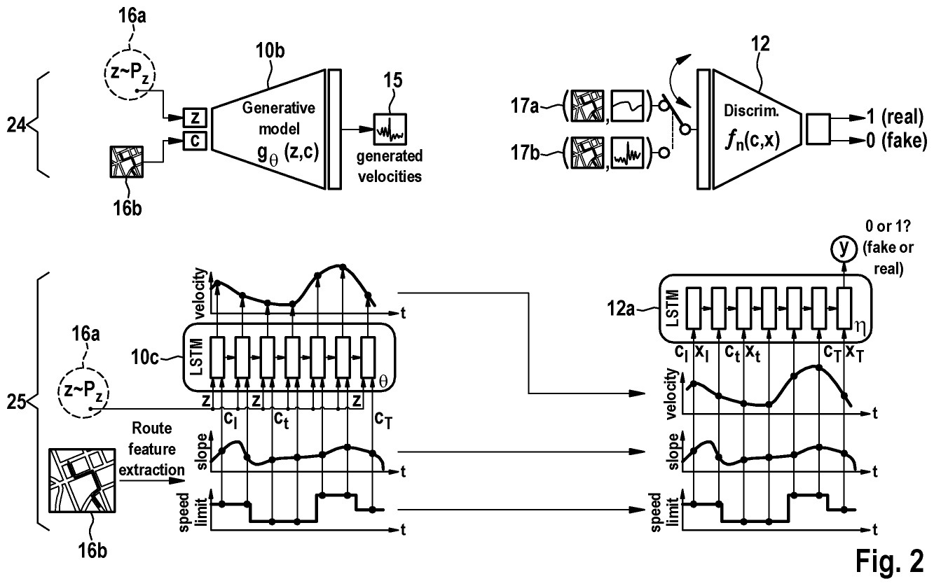

FIG. 3A illustrates a computer-implemented method for training a generative machine learning model for modelling operation profiles of a vehicle according to the first aspect.

According to an embodiment, in the at least one generation phase, the distribution is sampled to provide the plurality of synthetic data series.

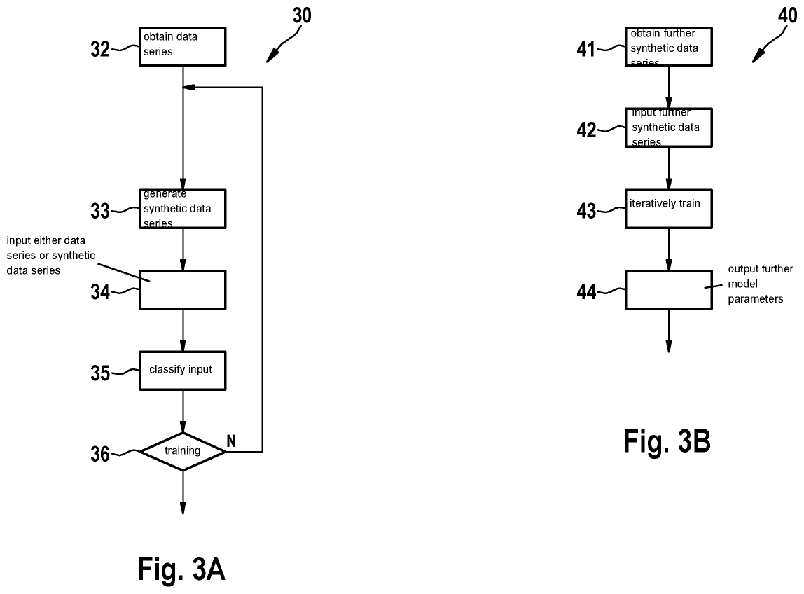

FIG. 4A illustrates an exemplary structure of a machine learning system 45 for training a generative model in a training phase.

The machine learning system 45 is an example of a Generative Adversarial Network GAN. Exemplary data such as a route and an associated velocity profile is obtained from a database containing real data samples 14. A generator 47 is then trained in the machine learning system 45 to generate example output data series, such as velocity profiles and/or routes. The velocity profiles are determined as a function of random input variables 16a. For example, a plurality of sampled data series in a data space X such as velocity extracted from a plurality of vehicle routes form a plurality of sampled data series in a data space X, although many other variables could be used alone, or in combination.

A distribution, e.g., a Gaussian distribution, is sampled to obtain a plurality of synthetic data series. The parameters of the distribution are, for example, selected so that the characteristics of the output distribution are representative of the intended synthetic data, such as a plurality of velocity profiles or gear settings.

The noise at each time step z_{1:T} sampled from the distribution is input to generator 47, which may optionally be provided with other variables in a conditional GAN. The generator 47 aims to generate synthetic data series that are undistinguishable from the real data samples 14. Iterative optimization of the generator 47 may be performed at each iteration by comparing X with \hat{X}, and computing a loss function. The parameters of the generator 47 may be adjusted by an approach such as gradient descent.

Accordingly, the generator 47 is trained to produce synthetic data series. The generator 47 may be used as the generative model 10a, 10b as discussed in FIG. 1A, for example.

Accordingly, the steps of the method of the first aspect of obtaining 32 a plurality of data series X in a data space, and generating 33 at least one synthetic data series g, based on the plurality of samples in the predefined distribution may be implemented according to the machine learning system 45 illustrated in FIG. 4A.

In an example, the step of inputting 34 into the discriminator model either (i) a data series from a plurality of sampled data series, or (ii) a synthetic data series from the at least one synthetic data series is performed by selecting one or more synthetic data series from the generator output 47, or selecting a data series from real input data, such the real input samples 14, for example.

A GAN discriminator 12, 12a operates by extracting some latent features (that are not necessarily interpretable) and uses these features to decide whether or not the input sample is real or synthetic (generated by generator 10a, 47). The discriminator 12a produces, for example a real number ƒᵣₙₙ (x_{1:T}) as a score.

A positive value of the score, for example, means the discriminator 12, 12a deems the sample to be real. A negative value of the score, for example, means that the discriminator deems the sample to be synthetic (fake). The feature extraction may be performed by a neural network.

Alternatively, the score may be a binary value with “1” indicating a “real” sample, and “0” indicating a “fake” sample, for example.

This specification proposes a new discriminator design for the purpose of classifying 35 the input to the discriminator model as either real or synthetic (fake) in a discrimination phase of the machine learning model.

The key idea is that a separate function module ƒₑₓₚ 26 is added to the GAN discriminator. The separate module is configured to extract additional information, such as expert features, and use them as a component of the discriminator score. This means that the discriminator 12, 12a trains the generator 47 to provide synthetic data series having a probability density function that approximates real data series.

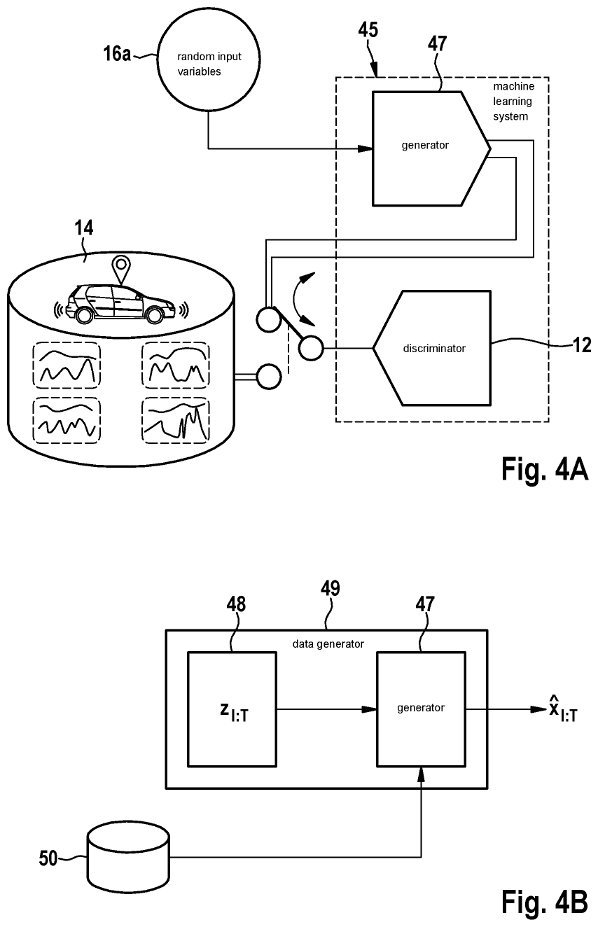

FIG. 5 illustrates the exemplary structure of the discriminator 12 of a machine learning system according to the first aspect. The discriminator comprises a first function 12a and a second function 26. A plurality of inputs of the first function comprises a plurality of sequential samples of the real data series x_{1:T}, or the synthetic data series \hat{x}_{1:T}. The input lines of \hat{x}_{1:T} or x_{1:T} are denoted in FIG. 5 as being selectable for schematic purposes. Any data manipulation function enabling selection between a real data series x_{1:T} or a synthetic data series \hat{x}_{1:T} may be applied. It is assumed that the input samples of each synthetic data series \hat{x}_{1:T} or real data series x_{1:T} may be provided either as a serial sequence of a controlled number of samples, or as a parallel vector of samples. There is no rearrangement, mixing, or convolution of the synthetic data series \hat{x}_{1:T} or x_{1:T} in their sequential dimension, upon input to the first function 12a of the discriminator 12. In other words, the input to the first function 12a is a duplicate in time of the synthetic data series \hat{x}_{1:T} or x_{1:T}.

At least one input of the second function 26 comprises at least two samples of the synthetic data series taken from different positions of the synthetic data series.

In an example, the input to the second function 26 of the discriminator 12 is obtained from the output of the generator 10, wherein a first sample of the output of the generator 10 and an adjacent second sample of the output of the generator 10 are combined.

In an example, the input to the second function 26 of the discriminator 12 is exclusively obtained from the output of the generator 10. In an example, the input to the second function 26 does not comprise samples of environment conditions c_{1:T} over time (for example, slope or speed limit).

In an example, a first subset of the synthetic data series \hat{x}_{1:T} or x_{1:T} is input to the second function 26 at an offset to a second subset of the synthetic data series \hat{x}_{1:T} or x_{1:T}. In an example, the offset between the first and second set of samples is one element of the synthetic data series \hat{x}_{1:T} or real data series x_{1:T}, two samples, three samples, or four samples. In an example, the first and second subsets of the synthetic data series \hat{x}_{1:T} or real data series or x_{1:T}, are input to the second function 26 with a sample shift between them.

In an example, the first function 12a of the discriminator obtains at its input at least one synthetic data series \hat{x}_{1:T}, and optionally a series of measured environment conditions. For example, the first function 12a of the discriminator may obtain a combination of a synthetic data series from the generator 10a, and a series of environment conditions.

In an example, the first function 12a of the discriminator obtains at its input a synthetic data series \hat{x}_{1:T} or x_{1:T} representing velocity, and a series of environment conditions representing at least the slope and/or the speed limit. The plurality of sequential environment conditions over time are indexed to the plurality of sequential samples of the synthetic data series \hat{x}_{1:T} or x_{1:T} representing velocity.

In an example, the elements of the data series and the elements of the synthetic data series each represent a time series (are ordered in time). In another example, the elements of the data series and the synthetic data series each represent a distance-based series (are ordered relative to the datum point of a fixed location on a map).

In an example, the second function does not obtain at its input any environment conditions. In an example, the second function applies an expert function to the synthetic data series \hat{x}_{1:T} or x_{1:T}.

According to an embodiment, the input of the first function is a time indexed function of the input to the discriminator model, and the input of the second function is a differentiable function of the input to the discriminator model.

According to an embodiment, the first aspect further comprises combining the outputs of the first and second functions using a discriminator neural network.

The first function is a recurrent neural network, optionally a Long Short Term Memory Network.

The second function is obtained by projecting at least one of the synthetic data series and obtaining the result of the second function of the discriminator model based on a combination of the projected at least one synthetic data series and at least one data series from the plurality of data series.

The discriminator neural network optionally calculates a linear combination of the first and second functions of the discriminator model.

In an example, the data series comprised in the plurality of data series are either time series or distance series. The synthetic data series of the plurality of synthetic data series are either synthetic time or distance data series.

As one example, a series of values sampled from a distribution resulting from real or synthetic data series may be used as the additional information or expert feature

As one example, a series of velocity-acceleration pairs sampled from a distribution resulting from real or synthetic data series (optionally a velocity-acceleration histogram) may be used as the additional information or expert feature.

In the case that the expert feature is provided by samples drawn from a distribution representing a velocity-acceleration histogram, the second function 26 of the discriminator has the following form: the data series comprises elements representing xₜ as the velocity of the subject vehicle at timestep t. A further data series \dot{x}_{1:T} with \dot{x}ₜ representing the acceleration of the vehicle at time step t may be calculated, or input. The second function 26 of the discriminator can be described in the following manner:

$${f}_{e x p} ( {x}_{1 : T} ) = \frac{1}{T} {\sum }_{t} {f}_{proj} ( e ( {x}_{t} , {x}_{t - 1} ) ) \qquad ( 4 )$$

Where e(xₜ,xₜ₋₁)=[xₜ, \dot{x}ₜ] extracts expert features at least at one time step, and in an example at each timestep. In this example, a time step is represented by a step between consecutive elements of the data series. In an example, a projection function 26c projects at least one sample of the expert features ƒₚᵣₒⱼ: [symbol] to enable discrimination.

In an example, the input to the second function 26 of the discriminator 12 is obtained from the output of the generator 10, wherein a sample of the output of the generator 10 and an adjacent second sample of the output of the generator 10 are combined and projected according to ƒₚᵣₒⱼ(e(xₜ, xₜ₋₁)).

In an example, each input to the second function 26 of the discriminator 12 is obtained from the output of the generator 10, wherein each sample of the output of the generator 10 is combined with each adjacent second sample of the output of the generator 10 according to an expert function e(⋅).

In an example, each input to the second function 26 of the discriminator 12 is obtained from the output of the generator 10, wherein each sample of the output of the generator 10 is a convolution of the generator output.

In an example, at least one input to the second function 26 of the discriminator 12 is obtained from the synthetic data series \hat{x}_{1:T} or the real data series x_{1:T}. In an example, at least one input to the second function 26 of the discriminator 12 is obtained from the data series obtained from the data space X In an example, the inputs to the second function 26 of the discriminator 12 are obtained as a mixture from the synthetic data series \hat{x}_{1:T} and the data series obtained from the data space X.

In an example, the second function 26 of the discriminator applies an expert function (e(⋅)) to at least one of its inputs. Based on the output of the generator 10, the expert function (e(⋅)) may assess, for example, one or more of an integer number of vehicle stops per unit time, duration of vehicle acceleration to a predefined velocity, duration of vehicle deceleration to a predefined velocity, duration of vehicle deceleration to zero velocity, vehicle velocity versus route curvature, vehicle velocity versus route inclination, vehicle velocity versus total trip duration, integer number of gear changes per unit time, gear change function to reach a predefined velocity, gear change function to reach a predefined velocity, gear change function to reach zero velocity, gear change function versus route curvature, gear change function versus route inclination, gear change function versus total trip duration.

The effect in the example above is that, upon training the overall model, the discriminator 12 (in other words, classifier) learns to distinguish the distribution of fake velocity-acceleration pairs, and real velocity-acceleration pairs. Implicitly, the discriminator builds the data density of real and fake samples to find out which of the two is more probable, for a given input.

In an embodiment, the second function of the discriminator model is configured to sample from a distribution resulting from real or synthetic data series based on at least one data series representing vehicle velocity, and at least one synthetic data series representing synthetic vehicle velocity.

In an embodiment, the second function of the discriminator model is configured to evaluate a time spent at zero velocity based on at least one synthetic data series representing vehicle velocity.

In an embodiment, the plurality of data series describe a plurality of operation profiles of a vehicle comprising at least one of a velocity series, an engine temperature, engine speed, pedal positions, steering angle, or a gear change function of a vehicle driving along a route, and the input to the second function of the discriminator model comprises a plurality of velocity-acceleration pairs sampled from a series of values sampled from a distribution resulting from real or synthetic data series.

In an embodiment, the plurality of data series describe a plurality of operation profiles of an autonomous or semi-autonomous robot comprising at least one of a displacement series, a velocity series, or a series representing the position of an actuator of the autonomous or semi-autonomous robot.

According to an embodiment, the second function is obtained by projecting at least one of the synthetic data series and obtaining the result of the second function of the discriminator model based on a combination of the projected at least one synthetic data series and at least one data series from the plurality of data series.

According to an embodiment wherein the second function of the discriminator model is configured to contribute to the discriminator score by projecting one or more of the samples of the plurality of synthetic data series.

In an embodiment, D=1. In this case, the output of ƒₚᵣₒⱼ can be considered to be the discrimination output for the expert feature at a single time step. For example, when D=1 the discrimination output of the velocity-acceleration pair at a single time step is obtained. In an embodiment, D may be greater than 1 for a richer representation (to enable the mixing of expert features across more than one time step).

In an example, the ƒₚᵣₒⱼ projection function may be implemented as a series of dense layers of a multi-layer perceptron.

In an example, the ƒₚᵣₒⱼ projection function could be hand-crafted to project the inputs into the bins of the second function. In an example, the ƒₚᵣₒⱼ projection function could be hand-crafted to project the inputs into the bins of the expert feature of the second function. In an example, the ƒₚᵣₒⱼ projection function could be hand-crafted to project the inputs into the bins of the distribution representing the series of values sampled from a distribution resulting from real or synthetic data series, such as a velocity-acceleration histogram.

Many vehicle routes begin at a velocity of zero. Accordingly, in an example the velocity at the first timestep is assumed to be zero, and the acceleration may be computed at all subsequent time steps.

The output of the projection function ƒₚᵣₒⱼ may optionally be averaged in averaging unit 26b, to obtain the final discrimination ƒₑₓₚ(x_{1:T}) of the second function 26 (expert unit) of the discriminator 12.

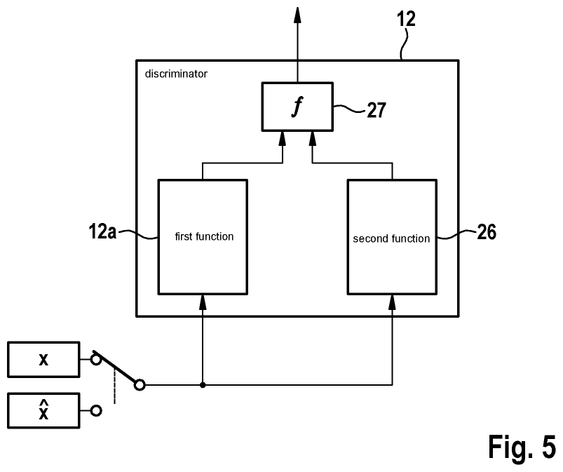

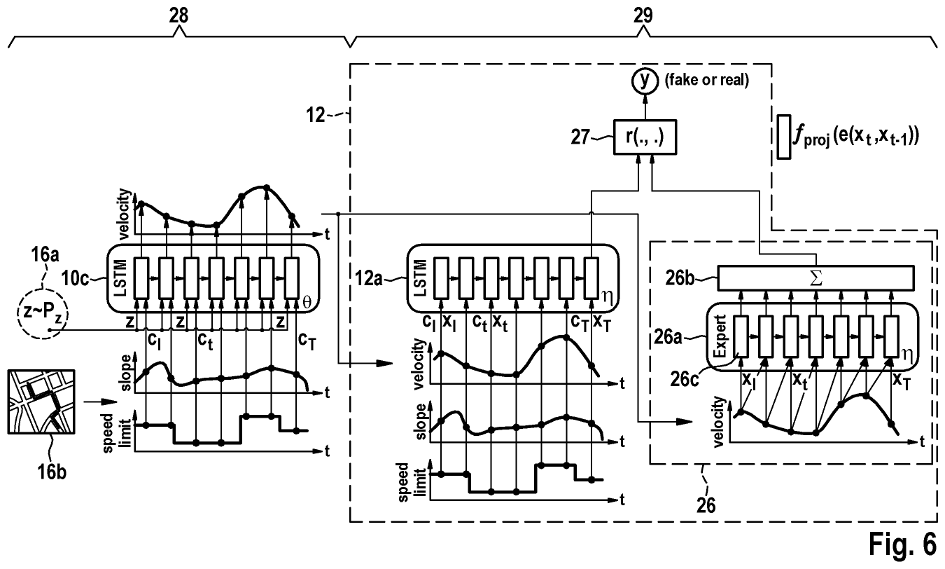

FIG. 6 illustrates an example of a detailed embodiment of the discriminator 12 of a machine learning system as used in a cGAN. The generator 10c illustrated in portion 28 of FIG. 5 is provided for reference. The discriminator 12 is illustrated in portion 29 of FIG. 5. The discriminator 12 comprises at least a first function 12a and a second function 26.

In an example, the discriminator 12 is applied to a GAN rather than a cGAN. In this case, the environmental variables shown in FIG. 6 (c₁, cₜ, c_{T}) would not be required. This case is not illustrated in FIG. 6.

Accordingly, the generator 10a produces a plurality of synthetic data series samples, such as a velocity series. The first function 12a of the discriminator 12 is referenced to time. In the specific case that the second function 26 computes acceleration from the velocity series, the acceleration is computed from pairs of neighbouring time steps as shown in FIG. 6, and extracts inputs to second function 26 in a predefined order. The acceleration \dot{x}₁ may be set to an arbitrary value, e.g. \dot{x}₁=0.

In another case where the second function is not based on acceleration, the second function 26 of the discriminator may be independent of the time structure. In the illustrated example, the second function 26 computes the acceleration from velocity and computes ƒₑₓₚ(x_{1:T}). A skilled person will appreciate that many other functions may be computed by the second function 26, either dependent or independent of the time structure of the data series or synthetic data series. The purpose of the second function 26 is to enable the plurality of synthetic data series to be more realistic by ensuring the discriminator is provided with extra expert information about specific vehicle or robot behaviour.

According to an embodiment, the trained generative machine learning model is configured to generate a plurality of synthetic data series having a statistical distribution that is more similar to the statistical distribution of the plurality of data series, as compared to the statistical distribution of a plurality of synthetic data series that would be generated without the use of the second function in the discriminator model.

The output of the first function 12a and the output of the second function 26 are joined in the combination block 27, optionally after applying projections ϕ(⋅) and ψ(⋅). Optionally, the projections ϕ(⋅) and ψ(⋅) may be performed by multi-layer perceptrons MLP. Optionally, the combination block 27 may be a sigmoid function or a linear combination, or another form of neural network.

According to an embodiment, the output of the discriminator model is defined by

$$r ( {f}_{rnn} ( {x}_{1 : T} ) , {f}_{e x p} ( {x}_{1 : T} ) ) = λ ϕ ( {f}_{r n n} ( {x}_{1 : T} ) ) + ( 1 - λ ) ψ ( {f}_{exp} ( {x}_{1 : T} ) ) with λ ∈ [ 0 , 1 ]$$

wherein ƒᵣₙₙ(x_{1:T}) is the first function, ƒₑₓₚ(x_{1:T}) is the second function, and ϕ(⋅) and ψ(⋅) are projections, optionally implemented as multi-layer perceptrons

The previous example considered the use of a second function 26 in a discriminator 12 configured to sample from a distribution representing a velocity-acceleration histogram.

A second example will be discussed concerning vehicle velocity generation for emission simulation, or load collective analysis.

In the second example, the velocities of the vehicle are generated with the purpose of modelling emission, or the load on various vehicle components. Data generated in this manner can be used to train a model that can be used by a car during driving. In practice, such a model would be trained to characterise, in real-time, the fuel consumption, emission performance, energy demand, or wear on vehicle parts such as pumps or brakes.

In this example, the target variable is a time series of velocities. The second function 26 of the discriminator 12 is, in this example, a series of values sampled from a distribution resulting from real or synthetic data series of time spent at zero velocity, versus the total time travelled. This is beneficial because a vehicle journey involving many episodes spent at zero velocity may display higher emissions, or cause more component wear, compared to a vehicle journey that remains at a substantially constant speed between the beginning and end.

An example implementation of the second function 26 of the discriminator 12 in this case is:

$${f}_{e x p} ( {x}_{1 : T} ) = ρ ( {\sum }_{i} 1 - 2 * [ sigmoid ( temperature * {x}_{i} ) 0.5 ] - T ) \qquad ( 5 )$$

The term within the summation maps zero velocity to 1, and maps any non-zero velocity to approximately zero (given that only non-negative velocities occur). The temperature takes a default value of 1, but can be increased to get a steeper approximation of a step function. Temperature, in this case, is a term specific to sigmoid functions and does not refer to engine temperature of a vehicle. The function ρ(⋅) maps the inputs (time spent at zero velocity and total time travelled) into a feature space for discrimination. In an example, ρ(⋅) may be a multi-layer perceptron.

Accordingly, two detailed examples of the composition of the second function 26 of the discriminator have been presented to address different applications. However, a skilled person will appreciate that the second function 26 of the discriminator may be composed to address many instances of statistical skew dependent on the application area.

According to an embodiment, the second function of the discriminator model is configured to sample a series of values sampled from a distribution resulting from real or synthetic data series, for example at least one synthetic data series representing vehicle velocity, to provide a velocity-acceleration histogram based on.

According to an embodiment, the second function of the discriminator model is configured to evaluate a time spent at zero velocity based on at least one synthetic data series representing vehicle velocity.

According to an embodiment, the plurality of data series describe a plurality of operation profiles of a vehicle comprising a velocity series, an engine temperature, engine speed, pedal positions, steering angle or a gear change function of a vehicle driving along a route, and the input to the second function of the discriminator model is sampled from a series of values resulting from real or synthetic data series having a distribution representing a velocity-acceleration function.

While the example of FIG. 6 considers the application to be vehicle velocity traces, and the second function 26 (expert feature) to be sampled from a series of values resulting from real or synthetic data having a distribution representing a velocity-acceleration histogram, the arrangement may be extended to many features, such as other environment variables c.

In an example, the second 26 function of the discriminator 12 (if present) should encode ƒₑₓₚ(x_{1:T}) in a differentiable manner.

Further functions of the discriminator may be added similar to the second function 26 that add further expert features to the discriminator. For example, the discriminator 12 may comprise a third, fourth, fifth, and sixth function, in which case the combination block 27 implementing the function r(⋅) would need to be altered to combine the optional additional third, fourth, fifth, and sixth functions. The second 26 function of the discriminator 12 (if present) should encode ƒₑₓₚ(x_{1:T}) in a differentiable manner.

In an example, the input to the second function 26 of the discriminator 12 is differentiable.

According to an embodiment, the input to the second function of the discriminator model defines one, or a plurality, of the following: (i) integer number of vehicle stops per unit time, (ii) duration of vehicle acceleration to a predefined velocity, (iii) duration of vehicle deceleration to a predefined velocity, (iv) duration of vehicle deceleration to zero velocity, (v) vehicle velocity versus route curvature, (vi) vehicle velocity versus route inclination, (vii) vehicle velocity versus total trip duration, (viii) integer number of gear changes per unit time, (ix) gear change function to reach a predefined velocity, (x) gear change function to reach a predefined velocity, (xi) gear change function to reach zero velocity, (xii) gear change function versus route curvature, (xiii) gear change function versus route inclination, (xiv) gear change function versus total trip duration.

A variant of the second function 26 may be used as an evaluation metric of the optimization iteration. In addition to using the expert features to train the GAN (cGAN), it is possible to use the second function 26 to assess the quality of the generated output of the machine learning model. For such an evaluation step, non-differentiable expert features or non-differentiable functions such as a random forest classifier can also be used, for example.

In this way, the features also serve as stopping criterion for the trained model. While the stopping criterion may be used to evaluate the quality of a model, it may also guide the training process and allows for early stopping of the training procedure if the stopping criterion falls below a desired threshold. Without a stopping criterion based on expert features, such a procedure is not possible, because the loss function of a GAN is often oscillatory.

According to an embodiment, there is provided the step of stopping the iterative training of the generator model using an stopping criterion, wherein the stopping criterion is obtained by evaluating at least one synthetic data series generated by an iteration of a generator model using the second function of the discriminator model, wherein the second function outputs the stopping criterion.

As a first example of using the second function 26 of the discriminator 12 to stop the training process, the case of vehicle velocity generation for emission simulation, or load collective analysis (component wear) is considered.

The velocities of the vehicle are generated to model emission or the load on various vehicle components. The target variable is a time series of velocities. The second function 26 of the discriminator 12 is configured to sample from a distribution representing a velocity-acceleration histogram for a vehicle or scenario of interest. The evaluation metric is applied by obtaining a set of real and synthetic time series samples. A classification model (such as a random forest) is trained, to predict the class of the velocity trace (real versus synthetic).

For a well-trained model, the accuracy of the classification between the two options should be close to random—that is, 50%.

Tracking this accuracy as the training of the discriminator and the training of the generator proceeds also provides a good indicator of the performance of the generator 10.

In a further example of using the second function 26 of the discriminator 12 as an evaluation metric, the case of vehicle velocity generation for emission simulation, or load collective analysis is again considered.

As a first example of using the second function 26 of the discriminator 12 to stop the training process, the case of vehicle velocity generation for emission simulation, or load collective analysis (component wear) is considered.

The velocities of the vehicle are generated to model emission or the load on various vehicle components. The target variable is a data series of velocities. The second function 26 of the discriminator 12 is configured to obtain the time spent at zero velocity for a vehicle or scenario of interest.

The evaluation metric is the mean and the standard deviation of the time spent at zero velocity for the real, and, synthetic data series of velocities. For a well-trained model, these metrics should be the same for the real and the synthetic data series of velocities. In addition to mean and standard deviation, any other metric (or measure) for comparing probability distributions can be used (such as the KL divergence).

It is not essential that the machine learning model trained according to the method of the first aspect is a GAN or cGAN. Any adversarial machine learning model having a generator may be applied. For example, an adversarial autoencoder comprising a discriminator comprising the second function 26 may be provided. Accordingly, in an embodiment, the generative machine learning model according to the first aspect is one of a GAN, conditional GAN, or an adversarial autoencoder.

According to a second aspect, there is provided a computer-implemented method for generating synthetic data samples representing synthetic operation profiles of a vehicle or robot using a generative machine learning model. The method comprises:
configuring a generative machine learning model according to a plurality of model parameters obtained according to the method of the first aspect;
obtaining a plurality of samples by sampling from a distribution configured to provide pseudo random vectors;
decoding the plurality of the samples of the distribution to obtain a further plurality of synthetic data samples in the data space; and
outputting the further plurality of synthetic data samples representing synthetic operation profiles of a vehicle or robot.

FIG. 3B illustrates a computer-implemented method for generating synthetic data samples representing synthetic operation profiles of a vehicle using a generative machine learning model according to the second aspect.

FIG. 4B illustrates an exemplary structure of a data generator 49 as it may be used during the generation of synthetic data series.

A sample generator 48 samples noise (z_{1:T}) from to a predefined probability distribution. A probability density may be ascertained, for example, using a density estimator as a function of ascertained noise at one or more time steps (z_{1:T}) as trained in FIG. 4A. A trained generator 47 (trained adversarially against a discriminator with a second function 26 implementing an expert input, as will subsequently be described) randomly draws a sample from the ascertained noise at one or more time steps (z_{1:T}). The generator 47 generates synthetic data series g based on the parameters of the generator 47 obtained during training, and the sample of the ascertained noise at one or more time steps (z_{1:T}).

The generator 47, for example, has previously been trained according to the first aspect. This involves applying to the adversarial training a second function 26 in the discriminator. The second function 26 biases the distribution that the discriminator tests for based on specific technical needs, such as a velocity-acceleration histogram in one example. The synthetic data series generated according to the second aspect therefore reflects real-world data more closely. According to an example, velocity profiles generated according to the second aspect are used to simulate emissions, and for the probabilistic assessment for compliance with emission standards.

According to an example, generated velocity profiles are used to optimise a software application.

According to an example, the generated velocity profiles are used to simulate vehicle emissions. The generated velocity profiles and/or simulated vehicle emissions may, in an example, be applied to a software representation (also referred to as a digital twin), of a vehicle component (such as an internal combustion engine), or an entire vehicle. The software representation may be configured to optimize various parts of a vehicle, or its components, according to the input velocity profiles. For example, the size, layout, and component configuration of an internal combustion engine or gearbox parts may be altered using the software representation of the vehicle or its components, based on the generated velocity profiles having improved accuracy to real use-cases. Accordingly, the application of the machine learning model trained according to the first aspect results in tangible design changes of technical components included in a vehicle or robot.

According to an example, the discriminator 12 including the second function 26 may be applied to evaluate potential speed profiles to assess whether a given route is relevant with regard to real driving behaviour.

According to an example, the data generation method according to the second aspect is used to assess the load (wear) individual components of the vehicle, such as a pump, over the lifetime of the vehicle.

According to an example, the data generation method according to the second aspect may be applied when a vehicle is driving. An engine control unit may generate velocity profiles according to the second aspect. Alternatively, an engine control unit may obtain from a memory pre-generated velocity profiles calculated according to the second aspect. The engine control unit may control engine commands dependent on the generated velocity profiles.

According to an example, the data generation method of the second aspect may obtain velocity or acceleration profiles. The velocity or acceleration profiles may be used to generate trajectories defining the depletion of a battery of an electric vehicle, the drive management of a hybrid vehicle, regeneration management of a regenerative braking system, or to improve the battery management of an electrical bicycle.

According to a third aspect, there is provided a computer-implemented method for training a further machine learning model for modelling operation profiles of a vehicle, comprising:
obtaining a further plurality of synthetic data series representing synthetic operation profiles of a vehicle as generated according to the computer-implemented method of the second aspect;
inputting the further plurality of synthetic data series representing synthetic operation profiles of a vehicle into a further machine learning model;
iteratively training the further machine learning model; and
outputting a further plurality of model parameters of the further machine learning model for modelling operation profiles of a vehicle.

The data generated by the computer-implemented method for generating synthetic samples according to the second aspect is more realistic, owing to the effect of at least the second function 26 of the discriminator 12 when training the GAN or cGAN according to the method of the first aspect. Therefore, the synthetic data generated according to the method of the second aspect is used in the third aspect to train a further machine learning model.

It is not essential that the further machine learning model trained according to the third aspect is a GAN or cGAN. Any machine learning model requiring data for training may use the synthetic data generated according to the method of the second aspect. An effect is that the further machine learning model is more accurately trained, because the synthetic data used to train it has been generated according to an adversarial model incorporating a discriminator 12 having a second function 26 that applies expert data to the discriminator.

According to a fourth aspect, there is provided an apparatus for training a generative machine learning model for modelling operation profiles of a vehicle or robot comprising adversarially training a generator model and a discriminator model stored in a memory. The apparatus comprises:

An input interface configured to obtain a plurality of data series from a data space, wherein each data series describes at least one operation profile of a vehicle, and a processor configured, during at least one generation phase when training the generative machine learning model, to generate at least one synthetic data series by sampling from a distribution.

The processor is configured, during at least one discrimination phase when training the generative machine learning model, to input into the discriminator model either (i) a data series from the plurality of obtained data series, or (ii) a synthetic data series from the at least one synthetic data series.

During the at least one discrimination phase when training the generative machine learning model, the processor is configured to classify the input to the discriminator model as either a data series from the data space, or a synthetic data series using at least a first and a second function of the discriminator model.

A plurality of inputs of the first function comprise a plurality of sequential samples of the synthetic data series, and at least one input of the second function comprises at least two data samples of the synthetic data series taken from different steps of the synthetic data series;

The processor is configured to iteratively train the generator model and the discriminator model of the generative machine learning model to yield a trained machine learning model comprising a trained generator model. The apparatus further comprises an output interface configured to output the trained machine learning model.

In an example, the apparatus 50 is a personal computer, server, cloud-based server, or embedded computer. It is not essential that the processing occurs on one physical processor. For example, the divide the processing task across a plurality of processor cores on the same processor, or across a plurality of different processors. The processor may be a Hadoop™ cluster, or provided on a commercial cloud processing service. A portion of the processing may be performed on non-conventional processing hardware such as a field programmable gate array (FPGA), an application specific integrated circuit (ASIC), one or a plurality of graphics processors, application-specific processors for machine learning, and the like.

The memory 58 of the apparatus 50 stores a computer program that, when executed by the processor 54, causes the processor 50 to execute the functionalities described by the computer-implemented methods according to the first, second, or third aspects.

According to an example, the input interface 52 and/or output interface is one of a USB interface, an Ethernet interface, a WLAN interface, or other suitable hardware capable of enabling the input and output of data samples from the apparatus 50.

In an example, the apparatus 50 further comprises a volatile and/or non-volatile memory system 58 configured to receive input observations as input data from the input interface 52.

In an example, the apparatus 50 is an automotive embedded computer comprised in a vehicle, in which case the automotive embedded computer may be connected to sensors and actuators present in the vehicle. For example, the input interface 52 of the apparatus 50 may interface with one or more of an engine control unit ECU providing velocity, fuel consumption data, battery data, location data and the like. For example, the output interface 56 of the apparatus 50 may interface with one or more of a plurality of brake actuators, throttle actuators, fuel mixture or fuel air mixture actuators, a turbocharger controller, a battery management system, the car lighting or entertainment system, and the like.

According to a fifth aspect, there is provided one or more computer program elements comprising at least (i) computer executable instructions for training, using machine learning, a generative machine learning model according to the method of the first aspect or its embodiments, and/or (ii) computer executable instructions for generating a synthetic data series according to the third aspect, and/or (iii) computer executable instructions comprising model parameters for providing a generative machine learning model trained according to the first aspect or its embodiments.

The computer program elements of the fifth aspect may comprise, for example, machine-readable instructions that are storable on a computer memory.

According to a sixth aspect, there is provided a computer readable medium comprising one or more of the computer program elements of the fifth aspect.

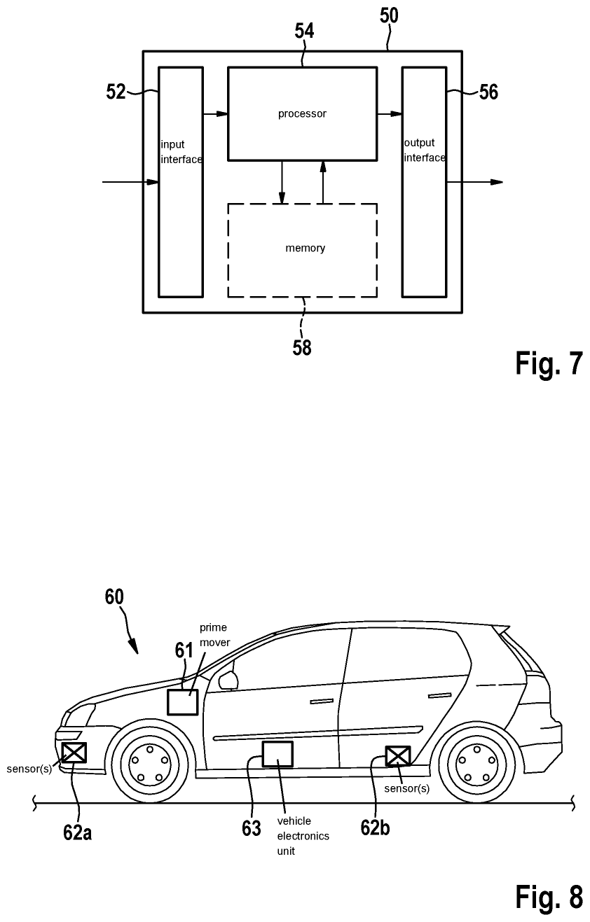

FIG. 8 schematically illustrates a vehicle according to the seventh aspect incorporating a controller configured to apply the model trained according to the first aspect.

According to a seventh aspect, there is provided a vehicle 60 comprising a prime mover 61 configured to provide a motive force to move the vehicle 60, a plurality of sensors 62a, 62b, and a vehicle electronics unit 63 configured at least to control the prime mover 61 based on feedback from one or more of the plurality of sensors 62a, 62b. The vehicle electronics unit 63 comprises a processor configured to instantiate and to implement a trained model responsive to at least one operation profile according to the second aspect.

The trained model is configured to receive input signals from the plurality of sensors 62a, 62b sensors, and to apply the input signals to the trained model. The processor is configured to compute one or more response signals using the trained model. The processor is configured to adjust a configuration of one or more of the prime mover 61, or another output actuator of the vehicle 60, in response to the response signals obtained via the trained model.

According to an embodiment, the prime mover 61 may be an internal combustion engine coupled to a fuel and exhaust system, or an electric motor coupled to a battery, or a hybrid powertrain.

An operation profile of the vehicle may preferably include, or be derivable from, one, some, or all of the following variables detectable by the plurality of sensors 62a, 62b of the vehicle: an accelerator pedal position of the vehicle, a brake pedal position of the vehicle, a position of the clutch of transmission of the vehicle, a gear of the transmission, speed of the motor vehicle, driving resistance of the vehicle, a tractive force of an internal combustion engine, a tractive force of an electromotive drive of the vehicle, a rotational speed of a component of the internal combustion engine, an air mass intake per unit time of the internal combustion engine, a pressure in an intake manifold of the internal combustion engine, a quantity of the high-pressure EGR (exhaust gas recirculation), a quantity of the low-pressure EGR, the timing of the closing of the inlet valve, the timing of the opening of the outlet valve, a position of the system for changing the compression of the internal combustion engine, an injection timing of the injections, a pressure in the high-pressure fuel accumulator (common rail), a coolant temperature of the internal combustion engine, or a temperature in the intake system of the internal combustion engine.

Further parameters that may be applied to the model, or parameters that could be considered during training, comprise a mass of the vehicle, a transmission ratio of the vehicle, a maximum drive power of a drive system of the vehicle, a maximum torque of the drive system, a type of transmission, a type of fuel, a specification of the hybridisation, a type designation of the engine, a type designation of the vehicle, characterisation of the route driven such as via GPS recordings, ambient temperature, slope parameter, ambient pressure.

For example, the trained model may be used whilst driving, so that a detected speed profile can be used to simulate potential future emissions, enabling the vehicle electronics unit 63 to adjust actuators of the prime mover 61 to ensure that control commands are provided to the prime mover 61 to ensure that vehicle emissions never exceed defined regulatory limits. In another example, the trained model may be used whilst driving to predict the load scenario of wear on a component, such as a pump or a brake disc, during operation.

The examples provided in the figures and described in the foregoing written description are intended for providing an understanding of the principles of the present. No limitation to the scope of the present invention is thereby intended. The present disclosure describes alterations and modifications to the illustrated examples. Only the preferred examples have been presented, and all changes, modifications and further applications to these are within the scope of the present invention.

What is claimed is:

1. A computer-implemented method for training a generative machine learning model for modelling operation profiles of a vehicle or a robot, including adversarially training a generator model and a discriminator model, the method comprises the following steps:
obtaining a plurality of data series from a data space, wherein each data series of the plurality of data series describes at least one operation profile of a vehicle or robot;
generating, during at least one generation phase when training the generative machine learning model, a plurality of synthetic data series by sampling from a distribution;
inputting into the discriminator model, during at least one discrimination phase when training the generative machine learning model, either (i) a data series from the plurality of obtained data series, or (ii) a synthetic data series from the plurality of synthetic data series;
classifying, during the at least one discrimination phase when training the generative machine learning model, the input to the discriminator model as either a data series from the data space or a synthetic data series, using at least a first and a second function of the discriminator model, wherein a plurality of inputs of the first function include a plurality of sequential samples of the synthetic data series, and at least one input of the second function includes at least two data samples of the synthetic data series taken from different steps of the synthetic data series; and
iteratively training the generator model and the discriminator model of the generative machine learning model to yield a trained machine learning model comprising a trained generator model.

2. The computer-implemented method according to claim 1, wherein an input of the first function is a time indexed function of the input to the discriminator model, and an input of the second function is a differentiable function of the input to the discriminator model.

3. The computer-implemented method according to claim 1, further comprising:
combining outputs of the first and second functions using a discriminator neural network, wherein:
the first function is a recurrent neural network, optionally a Long Short Term Memory Network, and/or the second function is obtained by projecting at least one of the synthetic data series and obtaining a result of the second function of the discriminator model based on a combination of the projected at least one synthetic data series and at least one data series from the plurality of data series.

4. The computer-implemented method according to claim 3, wherein the discriminator neural network calculates a linear combination of the first and second functions of the discriminator model.

5. The computer-implemented method according to claim 1, wherein each data series of the plurality of data series is either a time series or a distance series, and wherein each synthetic data series of the plurality of synthetic data series is either a synthetic time series or a synthetic distance data series.

6. The computer implemented method according to claim 1, wherein, in the at least one generation phase, a latent space is sampled to provide the plurality of synthetic data series.

7. The computer implemented method according to claim 1, further comprising:
stopping the iterative training of the generator model using at least one stopping criterion, wherein the at least one stopping criterion is obtained by evaluating at least one synthetic data series generated by an iteration of a generator model using the second function of the discriminator model, wherein the second function outputs the stopping criterion.

8. The computer-implemented method according to claim 1, wherein: (i) the second function of the discriminator model is evaluated on a series of values sampled from a distribution resulting from real or synthetic data series based on at least one data series representing vehicle velocity, and at least one synthetic data series representing synthetic vehicle velocity; or (ii) the second function of the discriminator model is configured to evaluate a time spent at zero velocity based on at least one synthetic data series representing vehicle velocity; or (iii) the plurality of data series describe a plurality of operation profiles of a vehicle including at least one of a velocity series, or an engine temperature, or engine speed, or pedal positions, or steering angle, or a gear change function of a vehicle driving along a route, and the input to the second function of the discriminator model includes a plurality of velocity-acceleration pairs sampled from a velocity-acceleration histogram; or (iv) the plurality of data series describe a plurality of operation profiles of an autonomous or semi-autonomous robot including at least one of a displacement series, or a velocity series, or a series representing the position of an actuator, of the autonomous or semi-autonomous robot.

9. The computer-implemented method according to claim 1, wherein an output of the discriminator model is defined by
$$r ( {f}_{rnn} ( {x}_{1 : T} ) , {f}_{e x p} ( x ) ) = λ ϕ ( {f}_{r n n} ( {x}_{1 : T} ) ) + ( 1 - λ ) ψ ( {f}_{exp} ( {x}_{1 : T} ) ) with λ ∈ [ 0 , 1 ] ;$$
wherein ƒᵣₙₙ(x_{1:T}) the first function, ƒₑₓₚ(x_{1:T}) the second function, and ϕ(⋅) and ψ(⋅) are projections, implemented as multi-layer perceptrons.

10. The computer-implemented method according to claim 1, wherein the data series input to the second function of the discriminator model defines one or a plurality, of the following: integer number of vehicle stops per unit time, duration of vehicle acceleration to a predefined velocity, duration of vehicle deceleration to a predefined velocity, duration of vehicle deceleration to zero velocity, vehicle velocity versus route curvature, vehicle velocity versus route inclination, vehicle velocity versus total trip duration, integer number of gear changes per unit time, gear change function to reach a predefined velocity, gear change function to reach a predefined velocity, gear change function to reach zero velocity, gear change function versus route curvature, gear change function versus route inclination, gear change function versus total trip duration, robot actuator position.

11. The computer-implemented method according to claim 1, wherein the trained generative machine learning model is configured to generate a plurality of synthetic data series having a statistical distribution that is more similar to a statistical distribution of the plurality of data series, as compared to a statistical distribution of a plurality of synthetic data series that would be generated without use of the second function in the discriminator model.

12. A computer-implemented method for generating synthetic data samples representing synthetic operation profiles of a vehicle or robot using a generative machine learning model, comprising:
configuring a generative machine learning model according to a plurality of model parameters obtained by:
obtaining a plurality of data series from a data space, wherein each data series of the plurality of data series describes at least one operation profile of a vehicle or robot;
generating, during at least one generation phase when training the generative machine learning model, a plurality of synthetic data series by sampling from a distribution;
inputting into the discriminator model, during at least one discrimination phase when training the generative machine learning model, either (i) a data series from the plurality of obtained data series, or (ii) a synthetic data series from the plurality of synthetic data series;
classifying, during the at least one discrimination phase when training the generative machine learning model, the input to the discriminator model as either a data series from the data space or a synthetic data series, using at least a first and a second function of the discriminator model, wherein a plurality of inputs of the first function include a plurality of sequential samples of the synthetic data series, and at least one input of the second function includes at least two data samples of the synthetic data series taken from different steps of the synthetic data series; and
iteratively training the generator model and the discriminator model of the generative machine learning model to yield a trained machine learning model comprising a trained generator model;
obtaining a plurality of samples by sampling from a distribution configured to provide pseudo random vectors;
decoding the plurality of the samples of the distribution to obtain a further plurality of synthetic data samples in the data space; and
outputting the further plurality of synthetic data samples representing synthetic operation profiles of a vehicle or robot.

13. An apparatus for training a generative machine learning model for modelling operation profiles of a vehicle or robot comprising adversarially training a generator model and a discriminator model stored in a memory, the apparatus comprising:
an input interface configured to obtain a plurality of data series from a data space, wherein each data series of the plurality of data series describes at least one operation profile of a vehicle or robot;
a processor configured to, during at least one generation phase when training the generative machine learning model, generate at least one synthetic data series by sampling from a distribution;
wherein the processor is configured to, during at least one discrimination phase when training the generative machine learning model, input into the discriminator model either (i) a data series from the plurality of obtained data series, or (ii) a synthetic data series from the at least one synthetic data series;
during the at least one discrimination phase when training the generative machine learning model, the processor is configured to classify the input to the discriminator model as either a data series from the data space, or a synthetic data series using at least a first and a second function of the discriminator model;
wherein a plurality of inputs of the first function include a plurality of sequential samples of the synthetic data series, and at least one input of the second function includes at least two data samples of the synthetic data series taken from different steps of the synthetic data series;
wherein the processor is configured to iteratively train the generator model and the discriminator model of the generative machine learning model to yield a trained machine learning model comprising a trained generator model; and
wherein the apparatus further comprises:
an output interface configured to output the trained machine learning model.

14. A non-transitory computer readable medium on which is stored a computer program for training a generative machine learning model for modelling operation profiles of a vehicle or a robot, including adversarially training a generator model and a discriminator model, the computer program, when executed by a computer, causing the computer to perform the following steps:
obtaining a plurality of data series from a data space, wherein each data series of the plurality of data series describes at least one operation profile of a vehicle or robot;
generating, during at least one generation phase when training the generative machine learning model, a plurality of synthetic data series by sampling from a distribution;
inputting into the discriminator model, during at least one discrimination phase when training the generative machine learning model, either (i) a data series from the plurality of obtained data series, or (ii) a synthetic data series from the plurality of synthetic data series;
classifying, during the at least one discrimination phase when training the generative machine learning model, the input to the discriminator model as either a data series from the data space or a synthetic data series, using at least a first and a second function of the discriminator model, wherein a plurality of inputs of the first function include a plurality of sequential samples of the synthetic data series, and at least one input of the second function includes at least two data samples of the synthetic data series taken from different steps of the synthetic data series; and
iteratively training the generator model and the discriminator model of the generative machine learning model to yield a trained machine learning model comprising a trained generator model.

15. A computer-implemented method for training a further machine learning model for modelling operation profiles of a vehicle, comprising:
obtaining a further plurality of synthetic data series representing synthetic operation profiles of a vehicle as generated by:
configuring a generative machine learning model according to a plurality of model parameters obtained by:
obtaining a plurality of data series from a data space, wherein each data series of the plurality of data series describes at least one operation profile of a vehicle or robot;
generating, during at least one generation phase when training the generative machine learning model, a plurality of synthetic data series by sampling from a distribution;
inputting into the discriminator model, during at least one discrimination phase when training the generative machine learning model, either (i) a data series from the plurality of obtained data series, or (ii) a synthetic data series from the plurality of synthetic data series;
classifying, during the at least one discrimination phase when training the generative machine learning model, the input to the discriminator model as either a data series from the data space or a synthetic data series, using at least a first and a second function of the discriminator model, wherein a plurality of inputs of the first function include a plurality of sequential samples of the synthetic data series, and at least one input of the second function includes at least two data samples of the synthetic data series taken from different steps of the synthetic data series; and
iteratively training the generator model and the discriminator model of the generative machine learning model to yield a trained machine learning model comprising a trained generator model;
obtaining a plurality of samples by sampling from a distribution configured to provide pseudo random vectors;
decoding the plurality of the samples of the distribution to obtain a further plurality of synthetic data samples in the data space; and
outputting the further plurality of synthetic data samples representing synthetic operation profiles of a vehicle or robot;
inputting the further plurality of synthetic data series representing synthetic operation profiles of a vehicle into a further machine learning model;
iteratively training the further machine learning model; and
outputting a further plurality of model parameters of the further machine learning model for modelling operation profiles of a vehicle.
